(19) United States
(12) Patent Application Publication
(10) Pub. No.: US 2005/0033500 A1
(43) Pub. Date: Feb. 10, 2005

(54) Stability and response of control systems

(75) Inventor: Andrew J. Moss, Bristol (GB)

Correspondence Address: OLIFF & BERRIDGE, PLC, P.O. BOX 19928, ALEXANDRIA, VA, 22320, US

(73) Assignee: ROLLS-ROYCE PLC., LONDON (GB)

(21) Appl. No.: 10/766,003

(22) Filed: Jan. 29, 2004

(30) Foreign Application Priority Data
Mar. 11, 2003 (GB) 0305594.4

(51) Int. Cl. G06G 7/70

(52) U.S. Cl. 701/100

(57) ABSTRACT

A control system is disclosed in which the error signal (e) is used to select a gain value (k) for use in the controller (4).

The present invention relates to improving stability and response of control systems, for example, but not exclusively, control systems used for controlling gas turbine engines using a temperature signal as an input.

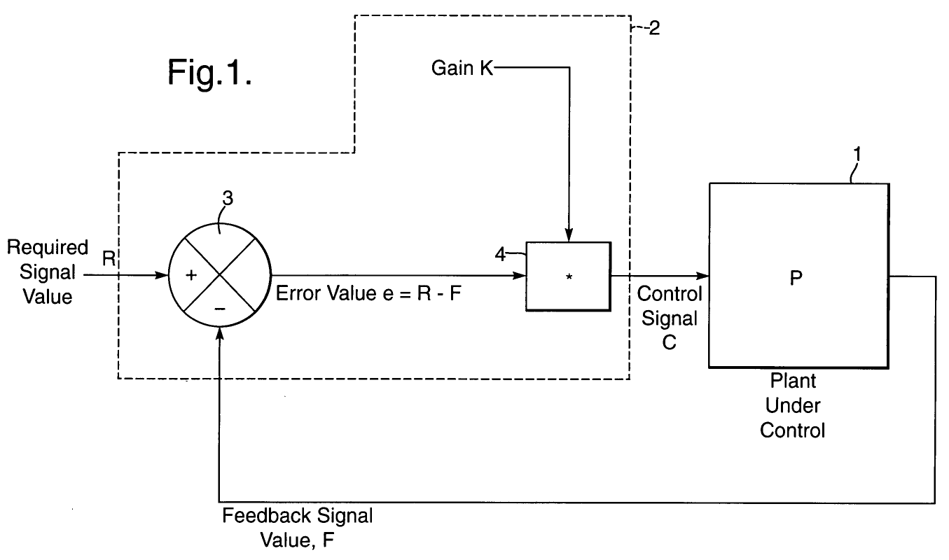

FIG. 1 of the accompanying drawings illustrates, schematically, a simplified control system and plant under control. The plant under control 1 receives control signals from the control system 2. A feedback signal F is supplied from the plant under control 1, to the control system 2.

The control system 2 receives a required signal value R and using an adder 3 generates an error value E. The error value E is equal to the difference between the required signal value R and the feedback signal F. This error signal is supplied to a gain multiplier 4 to produce the control signal C for supply to the plant under control. The gain multiplier 4 is supplied with a gain signal K, such that the control signal output from the control system 2 is equal to the error signal multiplied by the gain K. Accordingly, in previously considered systems, the gain K has been adjusted in dependence upon the conditions within the plant under control. These conditions, however, are external to the signal being controlled.

For example, the feedback signal could be a temperature signal, with the required signal value being a desired output temperature from the plant under control. Other parameters of the plant under control may affect the plant such that the temperature control gain needs to be adjusted, irrespective of the change in output temperature. For this reason, the gain K is adjusted with reference to those other parameters.

For example, the feedback signal could be a digitised analogue signal (TGT) output from a thermo coupler array in a gas turbine engine. The TGT signal is often polluted with noise, and this noise can cause instability in the input to the controller. The instability in the input signal to the controller can cause instability in the output control signal C, and so therefore can result in engine instability. This is clearly undesirable.

It is therefore desirable to provide a system and method which can reduce the effects of the noise signals in feedback signals supplied to the control system.

According to one aspect of the present invention, there is provided a control system comprising a comparison means for receiving a required signal, and an output unit operable to supply a control signal to a plant under control, the control signal being the error signal multiplied by a gain signal, wherein the gain value is chosen in dependence upon the error signal value.

It is emphasised that the term “comprises” or “comprising” is used in this specification to specify the presence of stated features, integers, steps or components, but does not preclude the addition of one or more further features, integers, steps or components, or groups thereof.

FIG. 1 schematically illustrates a previously considered control system;

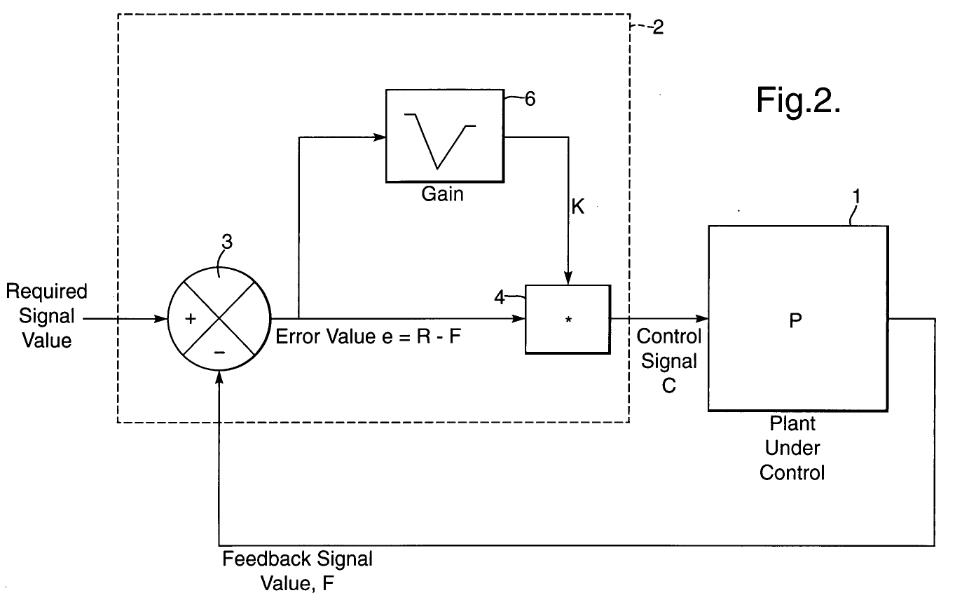

FIGS. 2 to 6 schematically illustrate respective embodiments of the present invention;

FIG. 2 of the accompanying drawings illustrates schematically an embodiment of the present invention. It will be readily appreciated that the invention can be embodied in hardware or software or a combination of the two. The FIG. 2 illustration is merely intended to set out in an easily understandable form the principles of the present invention.

The control system 2 of FIG. 2 differs from that shown in FIG. 1 by virtue of the provision of the gain unit 6, which supplies the gain signal K to the multiplier 4. The gain unit 6 receives the error value E as an input, and determines the gain value K according the value of the input error value E. The gain unit is preferably provided by a lookup table which stores the appropriate values of gain K for the range of input values to be expected.

In accordance with the present invention, the magnitude of the gain K is reduced as the magnitude of the error reduces. The relationship between the error signal and the gain K need not be linear, or indeed symmetrical about the zero error point.

An example of a gain value lookup table is given below.

| | Gain Lookup |
|---|---|
| Error | Table Entry |
| −5 | 2.5 |
| −4 | 2.5 |
| −3 | 2.5 |
| −2 | 2.0 |
| −1 | 1.0 |
| 0 | 1.0 |
| +1 | 1.0 |
| +2 | 3.0 |
| +3 | 4.0 |
| +4 | 4.0 |
| +5 | 4.0 |

The values are merely exemplary and are shown to given an idea of how the gain value varies with the magnitude of the error signal. The values in a practical example would be in “appropriate” units for the application concerned.

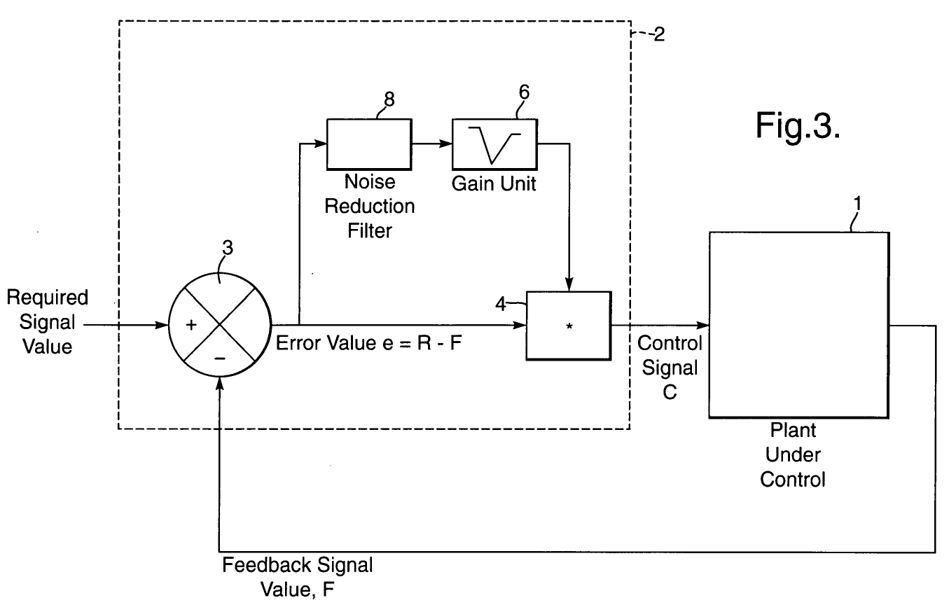

In some circumstances, the feedback signal F can suffer from high noise pollution, and this can lead to noise being propagated through to the error value E. Accordingly, an embodiment of the present invention is shown in FIG. 3 which includes a noise reduction filter 8, which can have any appropriate transfer function. For example, the transfer function can be given by the expression:

$$F ( s ) = \frac{1}{( τ + st )}$$

The output from the noise reduction filter is supplied to the gain unit for determining the gain value K. The FIG. 3 embodiment is intended to reduce gain fluctuations due to signal noise introduced into the error value signal E.

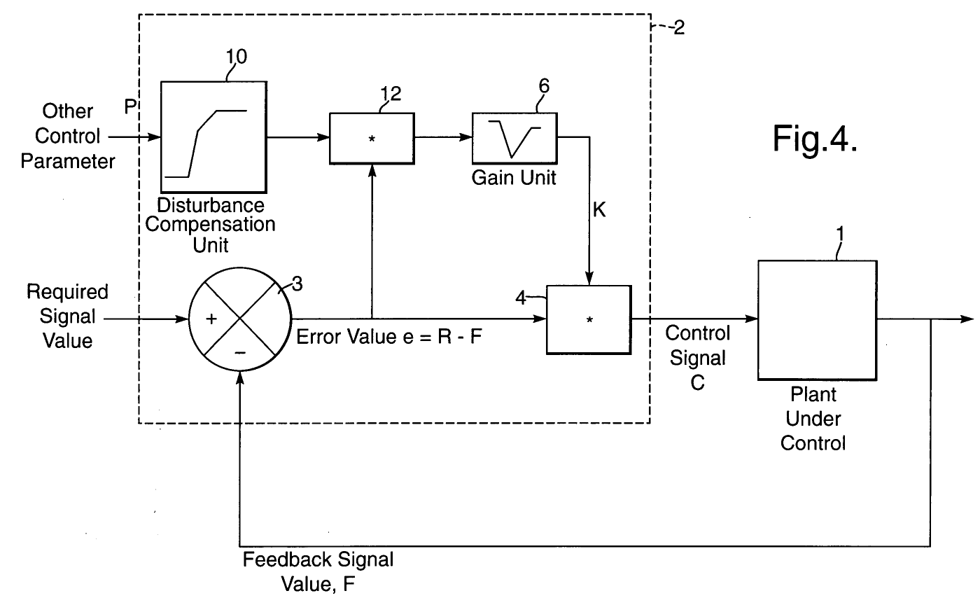

The scheme described with reference to FIG. 2 operates so that the gain K supplied to the multiplier unit 4 is reduced as the error signal approaches zero. This means that whilst the plant under control 1 is operating about the required signal value R, the gain of the control system is low. This has the advantage that the control system can have improved stability about that set point. However, this also means that the response of the control system to transient disturbances in other parameters of the plant under control 1, could result in the controlled parameter moving away from the set point, and being returned to that set point slowly, because the gain of the control system is low. The embodiment of the present invention shown in FIG. 4, includes a disturbance compensation unit 10 which is connected to receive a signal relation to at least one other control parameter of the plant under control 1. This disturbance compensation unit 10 operates to receive the control parameter P and to produce a compensation signal Q for supply to a second multiplier 12. The multiplier unit 12 serves to multiply the error value E by the compensation signal Q to produce a compensated error signal for supply to the gain unit 6. The purpose of the disturbance compensation unit 10 and second multiplier 12 is to allow the control gain to be modified further around the set point, when the operating conditions make this desirable. One example is when the parameter under control is close to a set point, but a sudden change in another parameter of the plant under control 1 would cause a large disturbance to the parameter of interest. In such a case, the control gain is increased by the disturbance compensation unit and multiplier 12 so that the control gain K can be large enough to enable speedy response of the control system 2. Having a larger value of gain K enables the control signal C to be larger for a given error value E, such that the transient disturbance caused by the other conditions of the plant under control 1 so that the control signal C is enlarged to enable fast response of the plant under control.

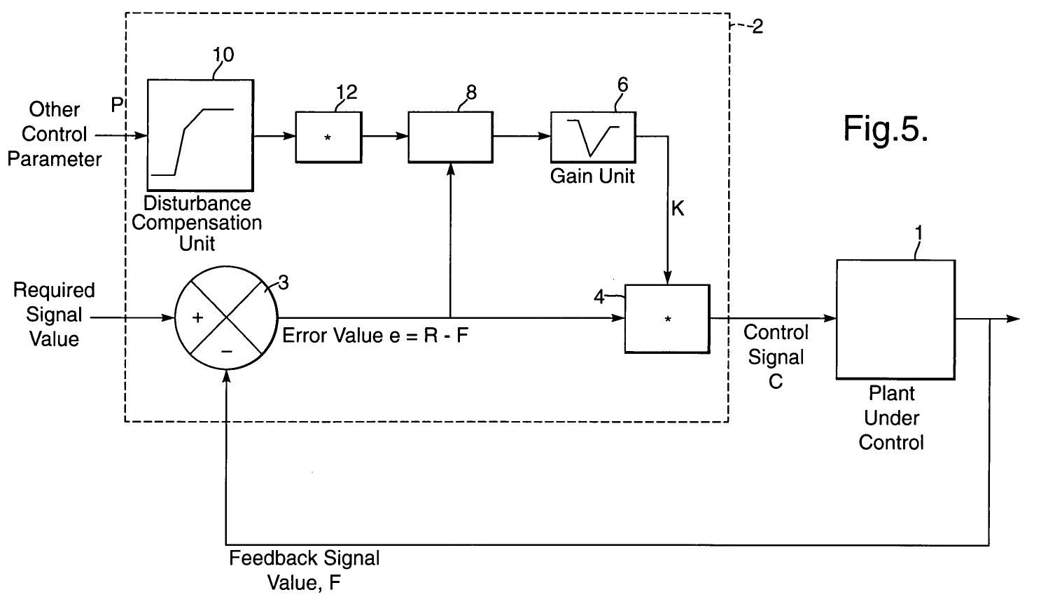

It will be readily appreciated that the noise reduction filter 8 and the disturbance compensation unit 10 can be combined in the present invention, and such an embodiment is shown in FIG. 5.

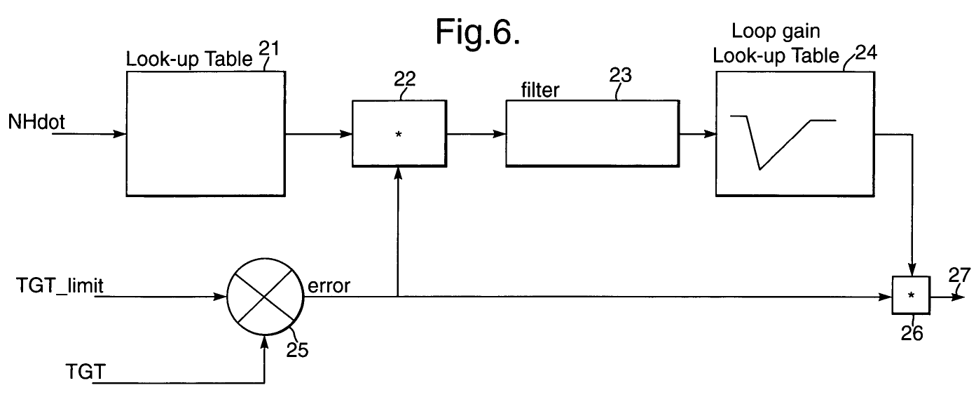

FIG. 6 of the accompanying drawings illustrates the control system when applied to a gas turbine engine control system. The parameter to be controlled in the FIG. 6 case is the turbine gas temperature (TGT) and is represented by a TGT signal. The reference value for the TGT signal is referred to as TGT_limit.

In FIG. 6, the TGT signal is received and compared with a reference signal TGT_limit. The comparison produces an error signal (error) which is output from an adder 25. The error signal e is supplied to a multiplier 22. The multiplier 22 serves to multiple the error signal e by a compensation signal Q in order to compensate for transient disturbances, as described above. The modified error signal eQ is supplied to a filter that removes noise before the signal is passed to the next part of the system.

The filtered error signal is supplied to a loop gain lookup table 24 which uses the filtered error signal as an input to determine a value of loop gain that will be applied to the remainder of the control circuit. The loop gain value is output from the lookup table 24 and multiplied with the error signal by a multiplier 26. This multiplied error signal is then supplied as an output 27 to the gas turbine engine.

The embodiment causes the control loop gain to be reduced as the required TGT reference point is approached by the actual TGT signal. The reduction in loop gain reduces the amplitude of the control fluctuations, or deviations from the datum; the gain being a function of the error between the datum and the controlled input. The error will fluctuate due to noise on the control input and this would normally cause the gain to fluctuate. However, the error signal is filtered to remove this noise before the gain is calculated. The smoothed error signal then produces a significantly smoother loop gain and this in turn improves the stability of the control loop which results in greater fluctuation rejection.

As described above, the stabilising technique described produces transient side effects, however. As a consequence of a reduction in the loop gain, the control loop will reject errors more slowly than previously. Accordingly, rapid changes in the error may result in poor transient performance. Restoring the loop gain to its nominal setting when transient effects are detected will solve this problem. In an embodiment of the present invention, this is achieved by increasing the size of the error signal which is input to the filter. In FIG. 6 a lookup table 21 is supplied with an input which relates to an acceleration parameter (Nhdot) of the engine. The look-up table 21 outputs the compensation value to a multiplier 22 to multiply the error signal. This adjustment increases the gain rapidly and allows the controller to reject the disturbance adequately. As an alternative to the acceleration signal, transient changes could be detected using the rate of change of the TGT signal, or another less noisy signal.

The overall principle of embodiments of the present invention is that the error signal itself is used to modify the gain of the control loop. The reduction in loop gain then reduces the fluctuation in the error, which further reduces the gain. The result is a reduction in fluctuations due to noise.

FIG. 7 illustrates a generalized method embodying the present invention, in which a feedback signal is received, and processed using the loop gain control of the present invention. The control signal is then supplied to the plant under control.

The present invention preferably operates in the digital domain so that the gain unit 6, filter 8, and disturbance compensation unit 10 can be implemented in software. As an alternative, the signals could be analogue signals and processed accordingly, or a combination of analogue and digital techniques can be used.

The technique taught by the present invention enables more stable engine control to be achieved at a steady state, whilst still maintaining acceptable transient performance.

Although the example given above relates to gas turbine engine control, it will be readily appreciated that the principles of the present invention can be applied to any kind of control system for controlling plant. For example, the control system embodying the present invention could be applied to aeronautical applications in general, and not just to gas turbine engine control.

1. A control system for supplying a control signal (c) to a controlled apparatus (P), the system comprising:
an error generation means (3) operable to produce an error signal (e) from a feedback value (F) relating to a measured operating parameter of a controlled apparatus (1, P), and a required value (R) relating to a desired operating parameter value of the controlled apparatus (1, P); and
a controller (4) operable to receive the error signal (e) and a gain signal (k), and to output a control signal (c) in dependence upon the values thereof,
wherein a gain selection means (6) is provided, which gain selection means is operable to receive the error signal (e) and to output a gain signal (k) to the controller (4) in dependence upon the value of the error signal (e).

2. A system as claimed in claim 1, wherein the controller (4) is operable to output a signal equivalent to the error signal multiplied by the gain signal.

3. A system as claimed in claim 1, wherein the error signal (e) equals the difference between the required value (R) and the feedback value (F).

4. A system as claimed in claim 1, wherein a filter means (8) is provided which is operable to filter the error signal (e) and to supply a filtered error signal to the gain selection means (6) in place of the error signal.

5. A system as claimed in claim 1, wherein a disturbance compensation means (10, 12) is provided which is operable to receive an input value relating to at least one other parameter value of the controlled apparatus, and to receive the error signal, and to produce a compensated error signal in dependence upon the input value and the error signal, and to supply the compensated error signal to the filter means or the gain selection means (6) in place of the error signal.

6. A system as claimed in claim 5, wherein the disturbance compensation means (10, 12) comprises a lookup table (10) for receiving the input value, and a multiplier (12) for receiving a compensation value from the lookup table, and for multiplying the error signal by the compensation value to produce the compensated error signal.

7. A method for controlling a controlled apparatus having a measured operating parameter, the method comprising:
generating an error signal (e) from a feedback value (F) relating to a measured operating parameter value of a controlled apparatus (I, P), and a required value (R) relating to a desired value of the operating parameter of the controlled apparatus (I, P); and
generating a control signal (C) in dependence upon the error signal (e) and a received gain signal (K),
wherein the gain signal is selected in dependence upon the error signal.

8. A method as claimed in claim 7, wherein the control signal is equivalent to the error signal multiplied by the gain signal.

9. A method as claimed in claim 7, wherein the error signal (e) equals the difference between the required value (R) and the feedback value (F).

10. A method as claimed in claim 7, wherein the error signal (e) is filtered and a filtered error signal is used to select the gain signal (6) in place of the error signal.

11. A method as claimed in claim 7, wherein a compensated error signal is produced using a disturbance compensation means (10, 12) which is operable to receive an input value relating to at least one other parameter value of the controlled apparatus, and to receive the error signal, and to produce the compensated error signal in dependence upon the input value and the error signal, the compensated error signal being supplied in place of the error signal.

12. A method as claimed in claim 11, wherein the disturbance compensation means (10, 12) comprises a lookup table (10) for receiving the input value, and a multiplier (12) for receiving a compensation value from the lookup table, and for multiplying the error signal by the compensation value to produce the compensated error signal.

13. A gas turbine engine controller including a control system as claimed in claim 1.

14. A controller as claimed in claim 13, wherein the measured operating parameter is temperature.

15. A method of controlling a gas turbine engine including a method as claimed in claim 7.

16. A method as claimed in claim 15, wherein the measured operating parameter is temperature.
